(19) United States
(12) Patent Application Publication
(10) Pub. No.: US 2022/0284475 A1
(43) Pub. Date: Sep. 8, 2022

(54) SELECTION AND PRESENTATION OF HYPER-RELEVANT CONTENT

(71) Applicant: T-Mobile USA, Inc., Bellevue, WA (US)

(72) Inventors: Parag Garg, Woodinville, WA (US); Spencer Schutz, Arvada, CO (US); Senthil Kumar Mulluppadi Velusamy, Redmond, WA (US)

(21) Appl. No.: 17/192,876

(22) Filed: Mar. 4, 2021

(51) Int. Cl. G06Q 30/02; G06N 20/00

(52) U.S. Cl. CPC G06Q 30/0256; G06Q 30/0261; G06Q 30/0271; G06N 20/00

(57) ABSTRACT

Described herein are techniques that may be used to provide hyper-relevant content to a user. Such techniques may comprise receiving, from a user device, usage data that comprises an indication of one or more actions taken by a user of the user device, identifying one or more connected devices in proximity of the user device, the one or more connected devices capable of presenting media content, determining, based on the one or more actions taken by the user of the user device, at least one media content to be presented to the user, and providing the at least one media content to a connected device of the one or more connected devices in proximity of the user device, the connected device caused to present the at least one media content.

### BACKGROUND

Advertisement placement has become increasingly sophisticated in recent years. With the advent of the Internet, advertising platforms are now able to use targeted advertisement placement, wherein ads are presented in a manner that is most accessible to parties that would be interested in those ads. Online advertising in general, however, has become less effective as most online users are constantly bombarded by all sorts of advertisements when online. Even with targeted ad placement, ads placed on popular websites or websites offering related services will still be missed by many interested users who have become accustomed to ignoring advertisements in general.

### SUMMARY

Techniques are provided herein for selecting and presenting hyper-relevant media content to a user. In some embodiments, such techniques comprise receiving usage data that includes an indication of recent actions taken by a user as well as an indication of connected devices in proximity to that user. The techniques further comprise selecting media content that is relevant to the recent actions taken by the user. Such media is then provided to at least one of the connected devices in proximity to the user in order to be presented.

In one embodiment, a method is disclosed as being performed by a content provider platform, the method comprising receiving, from a user device, usage data that comprises an indication of one or more actions taken by a user of the user device, identifying one or more connected devices in proximity of the user device, the one or more connected devices capable of presenting media content, determining, based on the one or more actions taken by the user of the user device, at least one media content to be presented to the user, and providing the at least one media content to a connected device of the one or more connected devices in proximity of the user device, the connected device caused to present the at least one media content.

An embodiment is directed to a computing device comprising: a processor; and a memory including instructions that, when executed with the processor, cause the computing device to receive, from a user device, usage data that comprises an indication of one or more actions taken by a user of the user device, identify one or more connected devices in proximity of the user device, the one or more connected devices capable of presenting media content, determine, based on the one or more actions taken by the user of the user device, at least one media content to be presented to the user, and provide the at least one media content to a connected device of the one or more connected devices in proximity of the user device, the connected device caused to present the at least one media content.

An embodiment is directed to a non-transitory computer-readable media collectively storing computer-executable instructions that upon execution cause one or more computing devices to perform acts comprising receiving, from a user device, usage data that comprises an indication of one or more actions taken by a user of the user device, identifying one or more connected devices in proximity of the user device, the one or more connected devices capable of presenting media content, determining, based on the one or more actions taken by the user of the user device, at least one media content to be presented to the user, and providing the at least one media content to a connected device of the one or more connected devices in proximity of the user device, the connected device caused to present the at least one media content.

Embodiments of the disclosure provide several advantages over conventional techniques. For example, unlike conventional content providers, embodiments of the proposed system may be configured to identify contextually-appropriate advertisements based on activity performed on the mobile device (e.g., recent searches, etc.). The system can then present a selected advertisement on a device in proximity to the mobile device. In some cases, the advertisements provided by the system may be interactive. For example, while the advertisement is being presented on the television, a user is able to provide input related to the advertisement via his or her mobile device. For example, while an advertisement is being played on the television about pizzas, the user may add or remove toppings to that pizza. In this manner, the user can help refine the selection of advertisements provided to that user. Such a system does not require that there be any relationship between the user and the devices on which the advertisement is presented. For example, a television selected to present the advertisement may not be associated with the account of the user who performed the search.

The foregoing, together with other features and embodiments, will become more apparent upon referring to the following specification, claims, and accompanying drawings.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a content provider platform that provides for selection and presentation of hyper-relevant content in accordance with some embodiments;

FIG. 2 is a block diagram showing various components of a computing system architecture that supports a selection and presentation of hyper-relevant media content to a user;

FIG. 3 depicts a block diagram showing an example process flow for selecting and providing hyper-relevant content to a connected device in proximity to a user in accordance with embodiments;

FIG. 4 depicts an illustrative example of a use case that may be implemented in accordance with at least some embodiments; and

FIG. 5 depicts a block diagram showing an example process flow for selecting and presenting content in accordance with some embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Described herein are techniques that may be used to select media content that is contextually relevant to a user as well as to present that selected media content to that user. In some embodiments, usage data is received from a user device indicative of actions taken by a user of the user device. In some cases, a set of connected devices may be identified as being in proximity to the user device. A media content may be identified as being relevant to the usage data. That identified media content may then be provided to at least one of the connected devices in the set of connected devices, such that the media content is caused to be presented by the connected device within the vicinity of the user device.

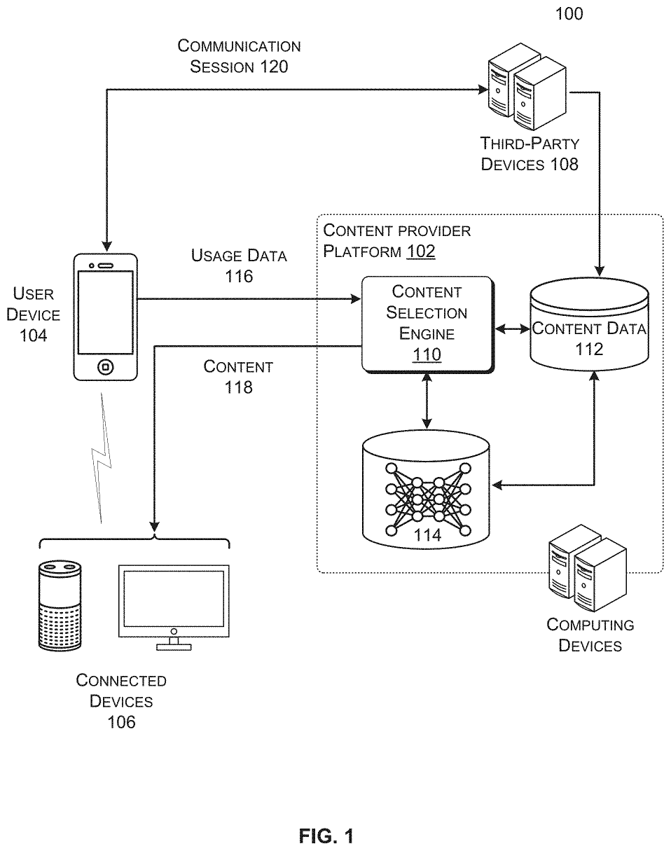

FIG. 1 illustrates an example architecture of a content provider platform that provides for selection and presentation of hyper-relevant content in accordance with some embodiments. In the content provider platform 100, a content provider platform 102 is in communication with at least one user device 104 that may be operated by a user. The user device 104 may further be in communication with a number of connected devices 106. The content provider platform 102 may be further in communication with one or more third-party devices 108 capable of providing the content provider platform with access to content.

A content provider platform 102 may be comprised of a number of computing devices configured to operate with a common goal. For example, the content provider platform may be implemented as a software application installed upon a number of computing devices that execute instances of content provider software. In some embodiments, the computing devices may comprise a distributed network of computing nodes (e.g., a cloud computing environment).

The computing devices of the content provider platform 102 may include instructions that implement a content selection engine 110 configured to identify content to be presented to one or more electronic devices (e.g., connected devices 106). The content selection engine 110 may have access to a database of media content (e.g., content data 112) capable of being presented to a user via a media presentation device. In some embodiments, the content selection engine 110 may receive an indication of one or more actions taken by a user of the user device 104, as well as an indication of one or more connected devices 106 in communication range of the user device 104, and may determine, based on this information, an appropriate piece of media content to be presented to the user of the user device. Additionally, the content selection engine may receive an indication of one or more connected devices 106 in communication range of the user device 104.

The content selection engine may be configured to identify one or more content formats capable of being presented via the connected devices 106. In some embodiments, the content selection engine 110 may use a trained machine learning model 114 configured to identify correlations between actions taken by a user device 104 and media content relevant to those actions. The trained machine learning model may have been generated using a machine learning algorithm by providing a set of actions taken via user devices and corresponding media content viewed via the user device and/or purchases completed by a user of the user device.

The machine learning model 114 may include any prediction model generated using suitable machine learning techniques that may be used to learn processes performed by users. In one example, such a machine learning algorithm may include a deep learning neural network. In some embodiments, the machine learning model 114 may be trained on data provided by one or more user device, such as the user device 104. For example, the machine learning model 114 may receive an indication of a search performed by a user of the user device as well as an indication of a purchase completed at a time proximate to the performed search. In this example, one or more search terms applicable to the conducted search may be correlated to the completed purchase within the machine learning model 114.

A user device 104 may be any electronic device capable of establishing a communication session with another electronic device. In some embodiments, the user device 104 may include in its memory a mobile application that enables at least a portion of the functionality described herein. The user device 104 may be capable of both long-range communication and short-range communication. In some embodiments, the user device 104 may be capable of remotely communicating with the content provider platform 102 via a long-range communication channel as well as with a number of connected devices 106 via a short-range communication channel. For example, the content provider platform may cause the user device 104 to capture information about one or more actions taken by the user (e.g., a search performed by the user, website viewed by the user, an application opened by the user, a gesture performed by the user, etc.) and provide that information to the content provider platform.

The user device 104 may be further configured to provide a set of identifiers for the connected devices to the content provider platform, the set of connected devices identified as being proximate to the user device. In some embodiments, a set of identifiers for the plurality of connected devices is generated via a device discovery process performed by the user device. In such embodiments, performing the device discovery process may comprise activating a short-range wireless communication channel (e.g., Bluetooth®, Wi-Fi, etc.) and collecting the set of identifiers from the plurality of user devices detected within range of the first user device via the short-range wireless communication channel.

A connected device 106 may be any suitable electronic device capable of presenting at least one piece of media content and capable of communicating with at least one other electronic device. In some embodiments, the connected device 106 may be an Internet of Things (IoT) device. Some nonlimiting examples of a connected device may include a smart television, a smart speaker, a computing device with audio/video capabilities, or any other suitable electronic device.

By way of illustrating interactions between various components of the system 100 as described herein, consider the following scenario. In such a scenario, a content provider platform may receive usage data 116 from a user device (e.g., a user's mobile phone) as well as an indication of a smart television in the vicinity of that user device. In this scenario, the usage data may include search terms for a search that was recently conducted by a user using the user device (e.g., via a web search). Based on those search terms, the content selection engine may identify a media content 118 from content data 112 that is determined to be relevant to the received search terms. Particularly, the content selection engine may identify a media content that comprises a video file capable of being presented on the smart television. In this scenario, the identified media content may be provided to the smart television, such that it is then presented to the user. It should be noted that there need not be any association between the user device and the connected device.

In some embodiments, a user's interaction with the content 118 presented via the connected device 106 may cause the user device 104 to establish a communication session 120 with a third-party device 108. For example, upon a user device interacting with a media content presented on the connected device, a browser application on the user device may be directed to a website or other data access point maintained by a third-party device associated with the media content. By way of illustration, upon a user using his or her mobile device to interact with a pizza advertisement displayed on a smart television, a browser application executed on that mobile device may be directed to a website operated by a pizza store associated with the pizza advertisement. In at least some of these embodiments, the user device 104 is then able to complete a transaction directly with the third-party device 108. In some cases, the user device 104 may obtain a uniform resource locator (URL) or other link from the accessed media content. The URL may include an identifier that may be used by the third-party device to identify the media content from which that identifier was obtained.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

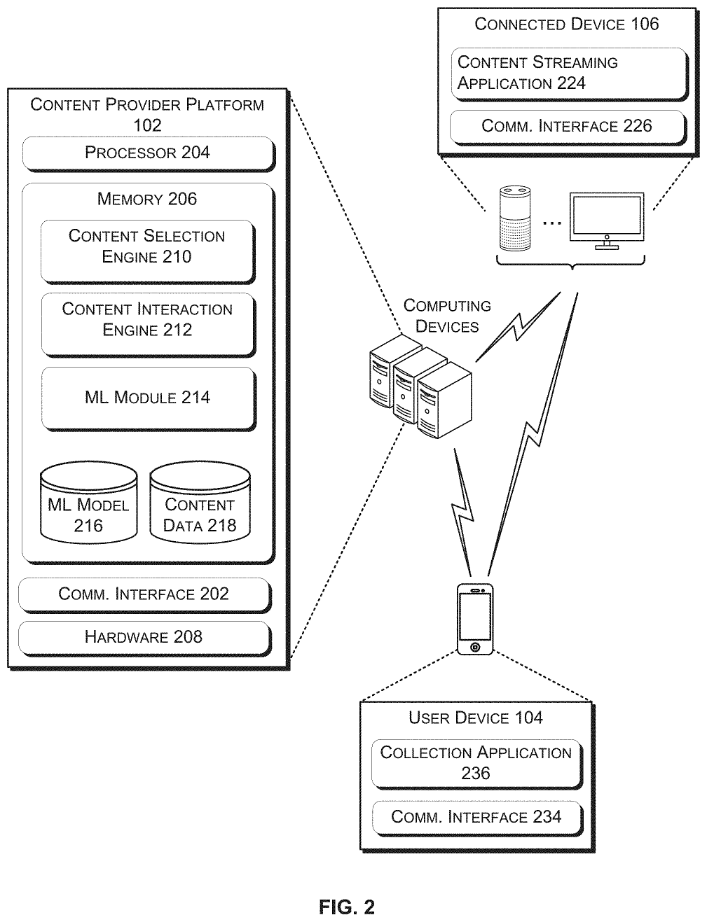

FIG. 2 is a block diagram showing various components of a computing system architecture that supports a selection and presentation of hyper-relevant media content to a user. The system architecture may include a content provider platform 102 that comprises one or more computing devices. The content provider platform 102 may include a communication interface 202, one or more processors 204, memory 206, and hardware 208. The communication interface 202 may include wireless and/or wired communication components that enable the content provider platform 102 to transmit data to, and receive data from, other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The content provider platform 102 can include any computing device configured to perform at least a portion of the operations described herein. The content provider platform 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The content provider platform 102 can include one or more virtual machines running virtual operating systems, or other computing architectures involving virtualization such as one or more flexible pools of logical storage devices that can be virtualized to maintain virtual storage devices for the computer. For example, the content provider platform 102 may include virtual computing devices in the form of virtual machines or software containers that are hosted in a cloud.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the content provider platform 102 may implement functionality from one or more software modules and data stores. Such software modules may include routines, program instructions, objects, and/or data structures that are executed by the processors 204 to perform particular tasks or implement particular data types. The memory 206 may include at least a module for selecting content to be presented to a user (e.g., content selection engine 210), a module for facilitating presentation of selected content on an identified connected device (content interaction engine 212), and a machine learning (ML) module 214 that generates correlations between media content and user actions. The data stores may include a trained machine learning model 216 that has been trained on user actions as well as content data 218 that includes media content available for presentation on a connected device. Additionally, the data stores may include content data 218 that includes media content capable of being presented on a connected device. In some embodiments, such media content may comprise advertisements or other product-related content.

The content selection engine 210 may be configured to, in conjunction with the processor 204, cause the content provider platform 102 to identify a piece of content from content data 218 that is relevant to one or more actions recently performed by a user. In some embodiments, the content selection engine 210 receives an indication of an action or actions taken by a user of a user device. Additionally, the content selection engine 210 may be configured to receive a set of identifiers for connected devices in short-range communication with the user device. The content selection engine 210 may determine, based on the action or actions recently performed by the user, a piece of media content from a library of available media content. To do this, the content selection engine 210 may provide received indication of the user action to a machine learning module 214 in order to generate a set of potential content from the library of content data relevant to the user action. In some embodiments, the content selection engine 210 may filter the content in the set of potential content based on the connected devices identified from the set of identifiers. For example, the set of potential content may be filtered based on the types of content (e.g., file formats, etc.) for which presentation can be supported by one of the connected devices.

The content interaction engine 212 may be configured to, in conjunction with the processor 204, cause the content provider platform to provide a selected piece of content to a connected device identified as being in proximity to a user. In some embodiments, the content provider platform receives a set of identifiers for a number of network-connected devices from a user device. As noted elsewhere, such a set of identifiers may be generated by a user device upon performing a device discovery process. In some embodiments, the set of identifiers may be generated based on a location of the user device as well as corresponding locations of each of the connected devices (e.g., via geofencing). The content interaction engine 212 may determine a type of each connected device based on the set of identifiers and may select a connected device from the determined connected devices. In some embodiments, a connected device may then be selected based on audio/video presentation capabilities of the connected device. In some cases, a database may be maintained that maps a number of types of connected device to corresponding capabilities. In these cases, the content interaction engine 212 may consult that database in order to select an appropriate connected device.

Once a connected device has been selected, the content interaction engine 212 may be configured to provide a piece of selected content to that connected device. In some embodiments, this comprises establishing communication with the connected device via a long-range wireless communication channel. In some embodiments, this comprises establishing communication with the connected device via a network connection (e.g., over the Internet). In some embodiments, this comprises identifying an existing active communication session associated with the connected device. For example, the content provider platform 102 may be included within a wireless carrier network. In this example, an active communication session may be identified by querying a core network of the wireless carrier network for communications directed to, or received from, the connected devices associated with the set of identifiers. The content interaction engine 212 may then gain access to the existing communication channel.

Once communication has been established with the connected device, the content interaction engine 212 may be configured to provide a piece of content (as selected by a content selection engine) to that connected device over the established communication connection. In some embodiments, the content interaction engine 212 may, upon providing the content to the connected device, be further configured to receive and process feedback from the user device. In some embodiments, such feedback may comprise an indication that a purchase has been completed using the user device. In some embodiments, such feedback may include an indication of one or more interactions between the user device and the connected device. The content provider platform 102 may be further configured to provide the received feedback to the machine learning module 214 in order to improve the accuracy of a trained machine learning model 216.

The machine learning module 214 may be configured to, in conjunction with the processor 204, generate a learning model that is trained to correlate a user action with a piece of media content. For example, the machine learning module 212 may comprise a deep neural network or other suitable machine learning algorithm that accepts user actions as input and user purchases and/or content viewing as outputs. Such a deep neural network may then determine correlations between the inputs and the outputs. It should be noted that while a deep learning model is mentioned, one skilled in the art would recognize that embodiments as described herein can be extended to different types/variants of learning models.

As noted elsewhere, the content provider platform 102 may be in communication with a number of connected devices 106 and/or user devices 104. A connected device 106 may be any suitable electronic device capable of presenting media content to a user and that has communication capabilities. The types and/or models of connected device 106 may vary, as may be a primary function performed by each of those connected devices.

One or more of the connected devices 106 may have installed upon them an instance of a content streaming application 224. In some embodiments, the content streaming application 224 may be configured to enable the connected device to access content as made available by a content provider. In some embodiments, the content streaming application 224 may be associated with a particular content provider, in that the content streaming application 224 is maintained by that content provider and is configured to present content made accessible by that content provider.

Each connected device may include a communication interface 226 that enables communication between the connected device 106 and at least one other electronic device (e.g., user device 104 and/or content provider platform 102). Such a communication interface may include some combination of short-range communication mechanisms as well as long-range communication mechanisms.

A user device 104 may be any electronic device capable of interacting with the content provider platform 102 as described herein. Examples of a user device 104 might be user device 104 as described with respect to FIG. 1 above. The user device 104 may include a processor and a computer readable memory as well as a communication interface 234. The computer readable memory of the user device 104 may include a collection application 236 that enables interaction between the user device 104 and the content provider platform 102. In some embodiments, execution of the collection application 236 on the user device 104 may cause the user device 104 to collect information related to one or more actions performed by a user of the user device. For example, the collection application 236 may access the memory of the user device to retrieve web browser cookies, a search history, application usage metrics, or any other suitable indication of a user's actions. The collection application 236 may then cause this information to be transmitted to the content provider platform. In some embodiments, the collection application 236 may execute as a background program on the user device 104 that performs the functionality described herein.

In some embodiments, the collection application 236 may further cause the user device to perform a device discovery process in order to identify connected devices in proximity of the user device. The collection application 236 may compile a set of identifiers for the identified connected devices and may cause that set of identifies to be transmitted to the content provider platform. In some embodiments, the collection application 236 may cause a current location of the user device (e.g., as obtained by a global positioning system (GPS)) to be transmitted to the content provider platform 102.

The communication interface 234 may include wireless and/or wired communication components that enable the mobile devices to transmit or receive data via a network, such as the Internet. In some embodiments, the communication interface 234 may include both short-range and long-range communication mechanisms. In some embodiments, communications between the user device and one or more connected devices may be established via a short-range communication mechanism of the communication interface 234 whereas communications between the user device and the content provider platform 102 may be established via a long-range communication mechanism.

In some embodiments, the collection application 236 may cause the user device 104 to interact with one or more connected device and/or the content provider platform. For example, a communication session may be established between a connected device 106 and a user device 104 via the respective communication interfaces 226 and 234. In some embodiments, the collection application 236 may provide the user device 104 with access to functionality that enables interaction with media content being presented on the connected device. For example, when viewing a piece of content on a smart television (e.g., an example connected device), the user may wish to interact with that content. In this example, the user may initiate a request to a collection application 236 on the user device, which may in turn establish a short-range communication session via communication interfaces 226 and 234. Information about the content may be transmitted over that communication session that enables the user to interact with the content.

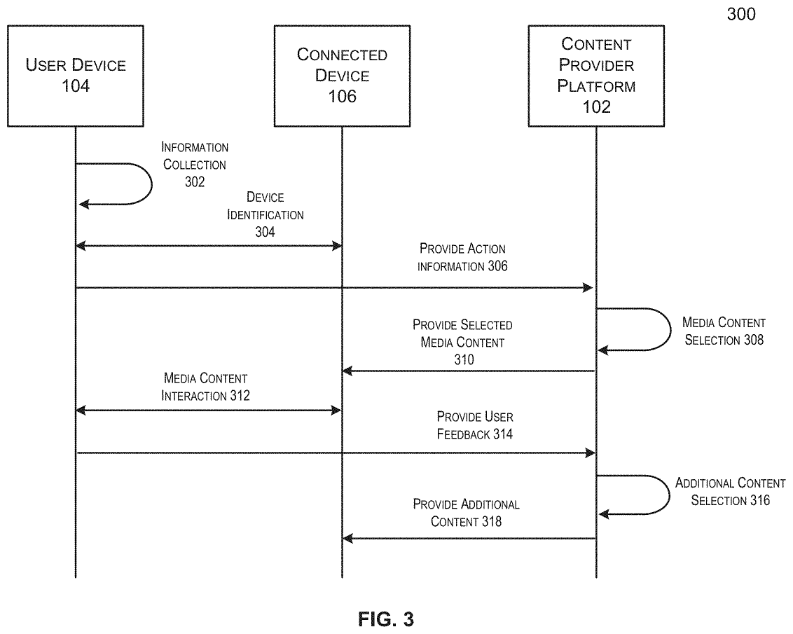

FIG. 3 depicts a block diagram showing an example process flow for selecting and providing hyper-relevant content to a connected device in proximity to a user in accordance with embodiments. The process 300 involves interactions between various components of the architecture 100 described with respect to FIG. 1. More particularly, the process 300 involves interactions between a content provider platform 102, user device 104, and a connected device 106.

Prior to the initiation of process 300, a user may use his or her user device 104 to perform one or more actions. In one example, a user may use the user device to perform an Internet search for a particular product or to visit a particular website. In another example, the user may execute a software application installed on the user device. In yet another example, the user may use a payment application installed on the user device to pay for goods and/or services. Each of these actions may result in a record of the action being placed in the memory of the user device. For example, an Internet search performed on the user device may result in an indication of the conducted search being added to a search history that is stored on the user device. In another example, visiting a website using the user device may result in a browser cookie being installed in the memory of the user device that indicates the website and a date/time associated with the website visit.

At 302 of the process 300, an application (e.g., collection application 236) executed on a user device may obtain information about one or more actions performed by the user while using the user device. For example, the application may retrieve one or more search terms from a search history stored on the user device. In another example, the application may retrieve browser cookies from the memory of the user device. In some embodiments, the application may only obtain information related to recent actions performed by the user. For example, the application may retrieve information on actions performed by the user within some threshold amount of time (e.g., within the last 30 minutes, etc.).

In some embodiments, the process 300 may further comprise identifying a number of connected devices in proximity of the user device at 304. To do this, the user device may activate a short-range wireless communication channel and may identify connected devices that are in range of the user device via that short-range wireless communication channel (e.g., those connected devices that are discoverable). The user device may then obtain device identifiers for each of the identified connected devices.

At 306 of the process 300, the user device provides information about one or more actions performed by a user using the user device to the content provider platform. In some embodiments, the user device may also provide a set of identifiers for each of a number of connected devices determined to be in proximity of the user device.

At 308 of the process 300, the content provider platform determines a piece of media content to be presented to the user. Such a determination may be made based on the information about the one or more actions performed by the user. For example, if the one or more actions performed by the user comprises a search conducted by the user, the process may comprise identifying media content associated with search terms identified in relation to the conducted search. In another example, if the one or more actions performed by the user comprises the user visiting a website, the process may comprise identifying media content associated with that website or a type of product discussed on that website.

In some embodiments, the selected media content may comprise an advertisement or other offer related to a product (e.g., a good or service). In some embodiments, when selecting a media content, a set of potential media content may be generated (e.g., using a trained machine learning model). The content provider platform may determine, for each piece of content within a content library, a degree to which that piece of content relates to the one or more actions performed by the user. In some embodiments, the degree to which that piece of content relates to the one or more actions performed by the user may be represented as a percentage. In some embodiments, a set of potential content may be generated by selecting media content for which the determined degree is greater than some threshold degree.

In some embodiments, the set of media content may include media content that relates to businesses located within some threshold distance of the user for whom the media content is being selected. The set of media content may include media content that is capable of being presented on one or more of the connected devices. For example, the set of potential media content may be selected so that it is composed of media content that is compatible with a particular type of connected device. In some embodiments, the content provider platform may also use information known about the user to select a piece of media content to be presented. For example, the content provider platform may store user preferences, a purchase history for the user, user demographic information or any other information that can be used to refine a selection of the piece of content.

In some embodiments, the content provider platform identifies a connected device in proximity to a user. In some cases, this is done based on a set of device identifiers provided to the content provider platform (e.g., by the user device). In some cases, the content provider platform determines a current location of the user device (e.g., based on GPS coordinates associated with the user device) as well as current locations of various connected devices (e.g., based on GPS coordinates associated with those connected devices).

At 310 of the process 300, the content provider platform provides the selected media content to a connected device identified as being in proximity to the user device. In some embodiments, the content provider platform communicates directly with the connected device. In some cases, the content provider platform transmits the content over a long-range communication channel, such as a data communication channel that uses a 4G mobile communications standard (e.g., long-term evolution (LTE)). In some embodiments, the content provider platform transmits the content to the connected device over a network connection (e.g., the Internet). Upon receiving the content, the connected device may be caused to play that content.

In some embodiments, the content provider platform may not communicate directly with the connected device at 310. Instead, the content provider platform may transmit the selected content to the user device. Upon receiving the selected content, the user device then transmits that content to the connected device over a short-range communication channel (sometimes referred to as “casting”).

In some embodiments, a user device is able to interact directly with a connected device at 312. In these embodiments, a user of the user device may have the ability to interact with the content as it is being presented on the connected device. For example, a software application installed upon, and executed from, the user device may cause the user device to establish a communication session with the connected device using a short-range communication channel. In some embodiments, information about the content may be communicated to the user device through the established communication session. In these embodiments, the user may be given the ability to interact with that data via the user device. For example, the user may be given the option to make a selection based on the content. In some cases, the content presented on the connected device may be updated or altered based on the selection made by a user. By way of illustration, the user may be presented with advertising content related to a particular good via the connected device. In this illustration, the user device may interact with the connected device to allow a user to select a color, size, type, or other suitable attribute for the product. The content presented on the connected device may then be updated to reflect the selection made by the user.

In some embodiments, the user device may provide feedback to the content provider platform at step 314. To do this, the user device may establish a long-range communication channel between itself and the content provider platform. In some embodiments, such feedback may comprise an indication that the user has completed a purchase in relation to the presented content. In some embodiments, the feedback may include an indication of one or more selections made by the user in relation to the content. In some embodiments, the feedback may include an indication of actions performed by the user subsequent to the presentation of the content.

In some embodiments, upon receiving feedback from a user device, the process 300 may comprise updating a trained machine learning model based on the received feedback. For example, a set of input data and output data may be updated to include data derived from the received feedback. The machine learning model may then be regenerated using the updated sets of data.

In some embodiments, the feedback may be used to select a second piece of content at 316. In some embodiments, this may comprise refining or otherwise updating the previously-presented content. In some embodiments, the second piece of content may be selected based on feedback received from the user device (e.g., as described at 314). For example, the second piece of content may be content that is narrower in scope, or more specific to indicated user preferences, than the previously-presented content.

At 318 of the process 300, the content provider platform provides the second media content to the connected device. In some embodiments, the content provider platform communicates directly with the connected device. In some cases, the content provider platform transmits the content over a long-range communication channel, such as a data communication channel that uses a 4G mobile communications standard (e.g., long-term evolution (LTE)). In some embodiments, the content provider platform transmits the content to the connected device over a network connection (e.g., the Internet). Upon receiving the second content, the connected device may be caused to play that second content.

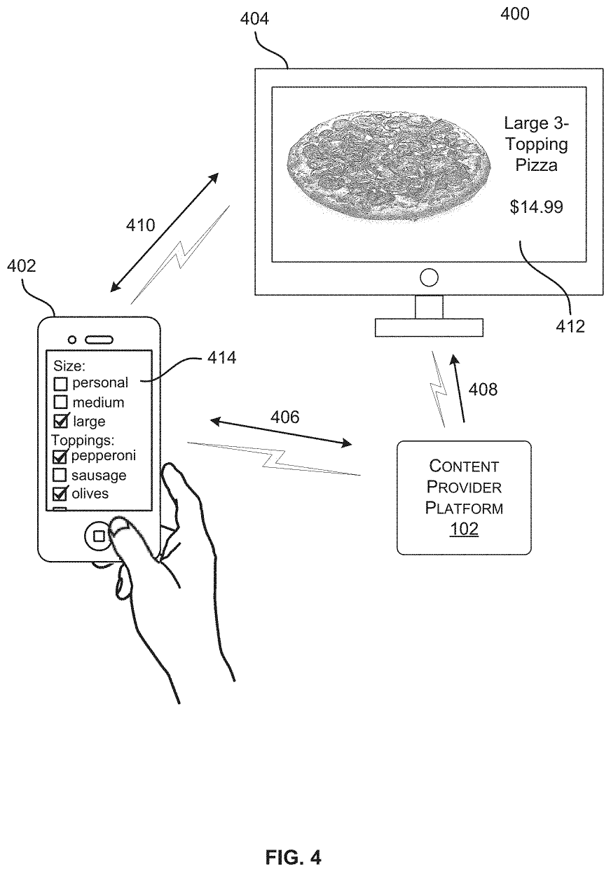

FIG. 4 depicts an illustrative example of a use case that may be implemented in accordance with at least some embodiments. In FIG. 4, a mobile phone (e.g., a user device) 402 is depicted as being capable of wireless communication with a content provider platform 102 as well as a smart television (e.g., a connected device) 404.

For purposes of illustration, consider a scenario in which a user has recently (e.g., within the last 30 minutes) conducted an online search for local pizza restaurants using the mobile phone 402. In this example, the details of the search conducted via the mobile phone are conveyed to the content provider platform via a first communication session 406. Communication session 406 may comprise a communication session initiated over a long-range communication channel.

In this scenario, the mobile phone 402 may activate a short-range wireless communication channel in order to perform a device discovery process. This allows the mobile phone to determine that a smart television 404 is in the vicinity of the mobile phone (by virtue of being detectable via the short-range channel). The mobile phone then obtains an identifier from the smart television and passes that identifier to the content provider platform over communication session 406.

Continuing with the above scenario, the content provider platform, upon receiving the details of the user's search for local pizza restaurants, identifies one or more advertisements (e.g., content) related to that search. In this case, the advertisement may be identified from a number of advertisements stored in a content library based on the advertisement's relevance to the conducted search, the location of a physical store associated with the advertisement with respect to the current location of the mobile device, and known preferences/purchase history for the user.

Once an advertisement has been identified by the content provider platform, that advertisement is provided to the smart television to be played. In some cases, the content provider platform establishes a communication session 408 between itself and the smart television. An exemplary communication session 408 may be established over a long-range communication channel (e.g., over a cellular network) or over a network connection (e.g., over the Internet). In cases in which the communication session 408 is established, the content provider platform may convey the selected advertisement directly to the smart television over that communication session.

In some cases, the content provider platform may not communicate directly with the smart television. In such cases, the content provider platform may convey the selected advertisement back to the mobile device via communication session 406. The mobile device may then establish a communication session 410 with the smart television. The mobile device may then “cast” the advertisement onto the smart television.

Once the advertisement has been received at the smart television, it may be displayed upon a display of the smart television via a graphical user interface (GUI) implemented on the smart television. In some embodiments, the mobile device may receive information about the advertisement. Such information may be presented via a graphical user interface 414 of the mobile device. In some cases, the user may select various options related to the advertisement. In this scenario, the user may select toppings and/or a size of pizza.

Once the user has made a selection, that selection is then conveyed back to the content provider platform. The content provider platform may then select a second advertisement based on the user's selections. In the above scenario, the content provider platform may select a second advertisement that relates more closely with the selections made by the user. That second advertisement is then provided to the smart television to be played in proximity of the user.

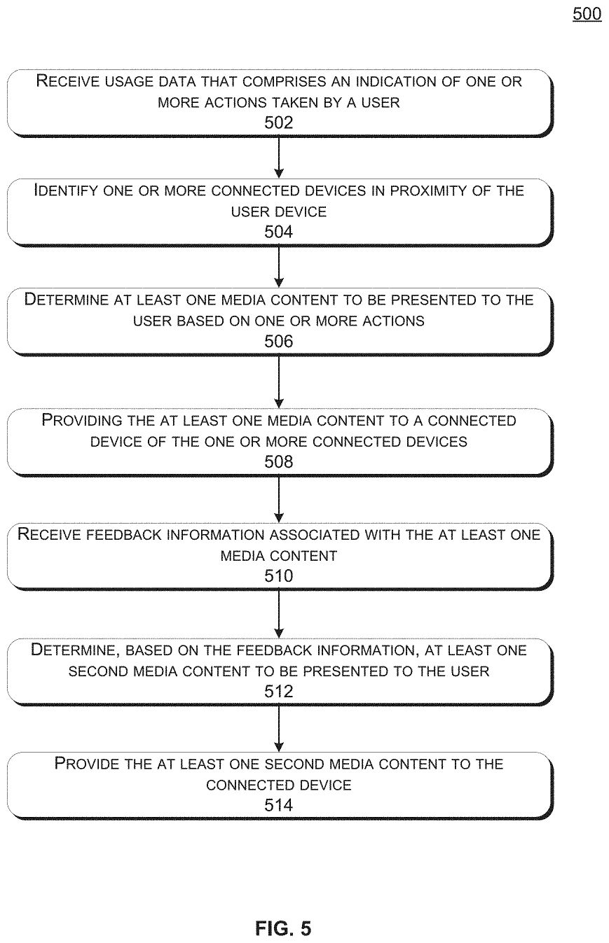

FIG. 5 depicts a block diagram showing an example process flow for selecting and presenting content in accordance with some embodiments. The process 500 may be performed by components within a content provider platform 102 as discussed with respect to FIG. 1 above.

At 502, the process 500 comprises receiving usage data that comprises an indication of one or more actions taken by a user. In some embodiments, the one or more actions taken by the user of the user device comprise a search performed by the user. In at least some of those embodiments, the usage information comprises one or more search terms associated with the search performed by the user. Such usage data may include any suitable information that can be used to ascertain actions taken by the user. For example, the usage data may comprise one or more of a search history of the user, information about browser cookies installed on the user device, or information about software applications executed on the user device.

At 504, the process 500 comprises identifying one or more connected devices in proximity of the user device. In some embodiments, the one or more connected devices in proximity of the user device are identified by the user device via performance of a device discovery process. For example, the user device may activate a short-range communication channel. In this example, the user device may obtain device identifiers for each electronic device that is discoverable via that short-range communication channel. In some embodiments, the one or more connected devices in proximity of the user device are identified based on a current location of the user device and current locations determined for each of the one or more connected devices. For example, a current location of the user device may be determined (e.g., via GPS) and that current location may be compared to current locations of a number other electronic devices. In some embodiments, the connected device comprises at least one of a smart television or a smart speaker.

At 506, the process 500 comprises determining at least one media content to be presented to the user based on one or more actions. In some embodiments, the at least one media content to be presented to the user is determined using a trained machine learning model. In some embodiments, the at least one media content to be presented to the user is determined based on information stored about the user. For example, the media content may be selected based on at least one of user preferences, user demographics, or historic purchase data for the user.

At 508, the process 500 comprises providing the at least one media content to a connected device of the one or more connected devices. In some embodiments, the at least one media content is provided to the connected device via a long-range communication channel. For example, the media content may be provided to the connected device via a cellular network connection. In some embodiments, providing the at least one media content to the connected device comprises transmitting the at least one media content to the user device such that the user device is then caused to transmit the at least one media content to the connected device via a short-range communication channel.

At 510, the process 500 comprises receiving feedback information associated with the at least one media content. In some embodiments, the feedback information comprises a selection made by a user of the user device. In some cases, the feedback information may be generated based on interactions between the user device and the at least one connected device.

At 512, the process 500 comprises determining, based on the feedback information, at least one additional media content to be presented to the user. In some cases, the at least one additional media content may be determined based on the selection made by the user. For example, additional media content may have a scope that is narrower in focus than the originally-selected media content, such that it is more relevant to the selections made by the user. At 514, the process 500 comprises providing the at least one additional media content to the connected device.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, from a user device, usage data that comprises an indication of one or more actions taken by a user of the user device;
identifying one or more connected devices in proximity of the user device, the one or more connected devices capable of presenting media content;
determining, based on the one or more actions taken by the user of the user device, at least one media content to be presented to the user;
providing the at least one media content to a connected device of the one or more connected devices in proximity of the user device, the connected device caused to present the at least one media content;
receiving, from the user device, feedback information associated with the at least one media content, the feedback information comprising a selection made by a user on the user device; and
updating the at least one media content presented on the connected device based on the received feedback information to reflect the selection made by the user.

2. The method of claim 1, further comprising:
determining, based on the feedback information, at least one additional media content to be presented to the user; and
providing the at least one additional media content to the connected device.

3. (canceled)

4. The method of claim 2, wherein the at least one additional media content is determined based on the selection made by the user.

5. The method of claim 2, wherein the feedback information is generated based on interactions between the user device and the at least one connected device.

6. The method of claim 1, wherein the one or more connected devices in proximity of the user device are identified based on a current location of the user device and current locations determined for each of the one or more connected devices.

7. (canceled)

8. A computing device comprising:
a processor; and
a memory including instructions that, when executed with the processor, cause the computing device to, at least:
receive, from a user device, usage data that comprises an indication of one or more actions taken by a user of the user device;
identify one or more connected devices in proximity of the user device, the one or more connected devices capable of presenting media content;
determine, based on the one or more actions taken by the user of the user device, at least one media content to be presented to the user;
provide the at least one media content to a connected device of the one or more connected devices in proximity of the user device, the connected device caused to present the at least one media content;
receive, from the user device, feedback information associated with the at least one media content, the feedback information comprising a selection made by a user on the user device; and
update the at least one media content presented on the connected device based on the received feedback information to reflect the selection made by the user.

9. The computing device of claim 8, wherein the one or more actions taken by the user of the user device comprise a search performed by the user.

10. The computing device of claim 9, wherein the usage information comprises one or more search terms associated with the search performed by the user.

11. The computing device of claim 8, wherein the connected device comprises at least one of a smart television or a smart speaker.

12. The computing device of claim 8, wherein the one or more connected devices in proximity of the user device are identified based on a current location of the user device and current locations determined for each of the one or more connected devices.

13. The computing device of claim 8, wherein the one or more connected devices in proximity of the user device are identified by the user device via performance of a device discovery process.

14. The computing device of claim 8, wherein the at least one media content is provided to the connected device via a long-range communication channel.

15. The computing device of claim 8, wherein providing the at least one media content to the connected device comprises transmitting the at least one media content to the user device, wherein the user device is then caused to transmit the at least one media content to the connected device via a short-range communication channel.

16. The computing device of claim 8, wherein the usage data comprises one or more of a search history of the user, information about browser cookies installed on the user device, or information about software applications executed on the user device.

17. The computing device of claim 8, wherein the at least one media content to be presented to the user is determined using a trained machine learning model.

18. A non-transitory computer-readable media collectively storing computer-executable instructions that upon execution cause one or more computing devices to collectively perform acts comprising:
receiving, from a user device, usage data that comprises an indication of one or more actions taken by a user of the user device;
identifying one or more connected devices in proximity of the user device, the one or more connected devices capable of presenting media content;
determining, based on the one or more actions taken by the user of the user device, at least one media content to be presented to the user;
providing the at least one media content to a connected device of the one or more connected devices in proximity of the user device, the connected device caused to present the at least one media content;
receiving, from the user device, feedback information associated with the at least one media content, the feedback information comprising a selection made by a user on the user device; and
updating the at least one media content presented on the connected device based on the received feedback information to reflect the selection made by the user.

19. The computer-readable media of claim 18, wherein the at least one media content to be presented to the user is determined based on information stored about the user.

20. The computer-readable media of claim 19, wherein the information stored about the user comprises at least one of user preferences, user demographics, or historic purchase data for the user.
